(19) United States
(12) Patent Application Publication
(10) Pub. No.: US 2006/0035032 A1
(43) Pub. Date: Feb. 16, 2006

(54) Method and composition for coating mat and articles produced therewith

(76) Inventors: Freddie Lee Murphy, Meridian, MS (US); Robert H. Blanpied, Suwanee, GA (US); Charles E. Diller, Meridan, MS (US)

Correspondence Address: NIXON & VANDERHYE, PC, 901 NORTH GLEBE ROAD, 11TH FLOOR, ARLINGTON, VA, 22203, US

(21) Appl. No.: 10/915,694

(22) Filed: Aug. 11, 2004

(51) Int. Cl. B05D 3/02; B05D 3/12

(52) U.S. Cl. 427/389.9; 427/372.2; 427/359

(57) ABSTRACT

A coated glass mat is formed by applying a coating mixture to a surface of a glass mat substrate, and then by drying the coated glass mat. As a result of the coating composition, the resultant mat attains a predetermined target spectral characteristic, e.g., a desired or target color. The coating mixture is formed by mixing together a mineral pigment filler, a solvent, a binder (e.g., organic latex binder), (optionally) a dispersing agent, and (optionally) a colorant. The type and amount of the mineral pigment filler is judiciously chosen to impart the predetermined spectral characteristic to the coated glass mat upon drying. In fact, although the coating mixture may include a separate, optional colorant, the mineral pigment filler is chosen as a primary color determinate for the completed coated glass mat. The primary determinative influence of the mineral pigment filler on the spectral characteristic of the coated glass mat is evident by the relative amounts of the mineral pigment filler and the colorant. In particular, a maximum ratio of “as received weight” of colorant to “dry weight” of filler is less than about 0.003; a ratio of “dry weight” of colorant to “dry weight” of the coating mixture does not exceed 0.4%. Advantageously, use of the inexpensive mineral pigment filler as the primary color determinate for the completed coated glass mat obviates the need is for larger amounts of more expensive colorant, thereby providing economy as well as efficiency in production.

### BACKGROUND

1. Field of the Invention

The field of the invention pertains to mats, webs, or facers for the building construction industry, such as gypsum board fiberglass facers and thermosetting polyiso foam insulation board facers, as well as processes for making/applying such facers and products utilizing such facers.

2. Related Art and Other Considerations

Many forms of weather resistant webbed sheets have been developed for the building construction industry for installation as an “underlayment” under shingles or under siding. Examples of such webbed sheets, also called “construction paper”, range from the old original “tar paper”, up to the spun-bonded polyolefin house wraps of the present day.

Various types of webbed sheets have also been used as a “facer” material for foamed insulation board laminates, with the laminates ultimately being utilized as side-wall or roofing insulation. For example, two facers for a laminate board typically sandwich or are situated on opposite surfaces of a core material, e.g., a laminated foam core, for example.

A popular material (“facer”) is the web of U.S. Pat. No. 5,112,678 to Gay et al (referred to herein as the '678 patent and incorporated herein by reference). The relatively fire-resistant web of the '678 patent has also served well as an underlayment in a Underwriter's Laboratory Incorporated fire-resistant rated roofing system over wooden decks, etc. For many years this material has served the building construction industry, e.g., as the facer for the laminated foam board product taught in U.S. Pat. No. 5,001,005, incorporated herein by reference. The foam board of U.S. Pat. No. 5,001,005 remains an important and integral part of both roofing and side-wall insulation. U.S. Pat. No. 5,112,678 and U.S. patent application Ser. No. 10/324,109 filed Dec. 20, 2002 (US 2003-0134079 A1), both incorporated herein by reference, show various techniques for applying coatings (such as the coatings of U.S. Pat. No. 5,112,678).

Sometimes a coated glass mat or product incorporating the same (produced, e.g., by the process or apparatus described above) is to be colored to attain a certain color. The concept of color space is useful in representing and modeling color phenomena. Color space is a three-dimensional space in which each point (having three coordinates) corresponds to a color, including both luminance and chrominance aspects. The tristimulus values R (red), G (green), and B (blue) form such a color space. This particular color space has three axes—L (lightness), a (red to green), and b (blue to yellow). As used herein, the coordinates employed to describe the color point along these three axes are referred to as the “L*a*b” coordinates, and are measured, e.g., by the Hunter Color Coordinate system. The tristimulus values are transformed (e.g., converted) into color space using, for example, the CIE 1976 L*a*b* equation. The CIE 1976 L*a*b* equation is explained in sundry prior publications including “CMC: Calculation of Small Color Differences For Acceptability”, AATCC Technical Manual/1992, pp. 322-324.

The tristimulus values cover every combination of red, yellow, blue, and white possible. Briefly, for the “L”, “a”, and “b” coordinates described above, the “L” scale is from zero (0), which is pure black, to 100, which is pure white. The “a” and “b” coordinates have negative values and positive values. A negative “a” is GREEN, and a positive “a” is RED; whereas, a negative “b” is BLUE, and a positive “b” is YELLOW. The higher the absolute number is, the more intense that color appears. Thus a “−b” of only 1.5 is a more pale blue than a strong blue having a “−b” value of 30.0. The same applies to the “a” coordinate. A clean, dark blue such as in the American flag, would have a low “L” number because the blue is dark; it would have an “a” value very near zero, and a “−b” in double digits.

To achieve coloring for a coated glass mat, typically (after drying) the coated glass mat has been covered (with dubious success) with a polymer latex-based “paint”. However, considerable paint was often required if a large color shift was needed, or if a large amount of material was to be covered.

Other coloration efforts have involved including a colorant in the coating mixture, e.g., in the form of dispersed pigment. Unfortunately, such colorants are typically considerably more expensive than other ingredients of the coated glass mat, and therefore the use of such dispersed pigments disproportionately increases the overall cost of an otherwise relatively inexpensive product.

Moreover, for reasons largely unrecognized, when using a dispersed pigment colorant, the resultant color of the coated glass mat was not identical, and in fact often dissimilar, to the ostensible color of the dispersed pigment utilized in the coating mixture. For example, if a yellow, coated glass mat is requested, it may turn out that, by adding an ostensible yellow pigment to the coating mix, a shade of green rather than yellow may result.

Also, shades of coloration of the completed coated glass mat typically varied from batch to batch as ingredients of the batches changed. Alternatively, differing amounts of colorant had to be added, largely on an empirically determined basis, if any aspirations to achieve consistent color were even to be attempted. In short, there was no conscious or deliberate way of controlling the coating mixture for sake of color consistency for large quantities of completed coated glass mats.

Not only was consistent coloration of coated glass mats not easily achievable, initially there was not much motivation for consistency since typically the coated glass mats were ultimately employed internally in structures without much, if any, exposure or visibility.

More recently, however, manufacturers in the construction industry in general have become more shrewd and savvy in marketing efforts, and have realized that customer loyalty can be engendered when a distinctive color is associated with the manufacturer's products. As such, the distinctive color serves as a “source-indicator” of the manufacturer's products, i.e., readily informs the consuming public that the product emanates from a particular manufacturer. To this end, at least one manufacturer has even overcome the color depletion doctrine in order to obtain U.S. trademark protection for a pink color of insulation materials, for example.

What is needed, therefore, and an object of the present invention, are techniques or methods for efficiently making low cost coated glass mat with a predetermined spectral characteristic, e.g., color.

### BRIEF SUMMARY

A coated glass mat is formed by applying a coating mixture to a surface of a glass mat substrate, and then by drying the coated glass mat. As a result of the coating composition, the resultant mat attains a predetermined target spectral characteristic, e.g., a desired or target color. In one mode, the predetermined or target spectral characteristic is a source-indicative spectral characteristic, e.g., a color which is consistent with coloration of products or goods emanating from a manufacturer or product source. Hopefully the spectral characteristic of the product or goods denotes or depicts to a consumer that the product, e.g., an insulation board or the like, which conspicuously incorporates or comprises the coated glass mat, emanates from the particular manufacturer or product source.

The coating mixture is formed by mixing together a mineral pigment filler, a solvent, a binder (e.g., organic latex binder), (optionally) a dispersing agent, and (optionally) a colorant. The type and amount of the mineral pigment filler is judiciously chosen to impart the predetermined spectral characteristic to the coated glass mat upon drying. In fact, although the coating mixture may include a separate, optional colorant, the mineral pigment filler is chosen as a primary color determinate for the completed coated glass mat. The primary determinative influence of the mineral pigment filler on the spectral characteristic of the coated glass mat is evident by the relative amounts of the mineral pigment filler and the colorant. In particular, a maximum ratio of “as received weight” of colorant to “dry weight” of filler is less than about 0.004; in some modes is less than about 0.003 (e.g., about 1-gram per 335-grams); and in some modes is as low as about 0.001 (e.g., about 0.25-gr/388.5-gr=0.000644). Alternatively, since the pre-dispersed liquid colorants are all roughly 50% dry solids content, the level of colorant used can be stated as the ratio of “dry weight” of colorant to the “dry weight” of filler, in which case the maximum ratio is about half as much, e.g., 0.002 (since, for example, 0.5/335 is 0.0015). Advantageously, use of the inexpensive mineral pigment filler as the primary color determinate for the completed coated glass mat obviates the need for larger amounts of more expensive colorant, thereby providing economy as well as efficiency in production.

In most cases, the spectral characteristic of the completed coated glass mat is different than a pre-mixture spectral characteristic of the mineral pigment filler, even though the mineral pigment filler so decisively affects the spectral characteristic of the completed coated glass mat.

In most modes, the preferable mineral pigment filler is limestone. The spectral characteristic of the completed glass mat, attained by use of a particularly selected limestone in the coating mixture, can be any source-indicative color, such as yellow, blue, pink, or silver for example.

In some modes, the source-indicative spectral characteristic of the completed glass mat is a general yellow coloration. Differing ones of these generally yellowish modes have somewhat different specific spectral characteristics. For instance, in one example such yellow mode the specific spectral characteristic is characterized substantially by the following coordinates in L*a*b color space: L=+78.6; a=+1.2; and b=+52.2. In another example yellow mode, the specific spectral characteristic is characterized substantially by the following coordinates in L*a*b color space: L=+83.87; a=+0.44; and b=+53.45. In all such yellow modes, the limestone is characterized by coordinates in L*a*b color space having the following ranges: 82≦L≦92; 0≦a≦+1.5; and, +2.0≦b≦+8.5. Likewise, the finished yellow product is characterized by coordinates in L*a*b color space having the following ranges: +75≦L≦+85; −1.0≦a≦+1.5; and, +50≦b≦+58. Oddly, the “a” can be a small negative if the “L” is over about +83 and the “b” over about +55, but no green can be seen by the naked eye; i.e., it is a good yellow color.

In one example yellow embodiment, a pre-mixture spectral characteristic of the mineral pigment filler is characterized substantially by the following coordinates in L*a*b color space: L=90.7; a=+0.96; and b=+8.46. A mineral pigment filler for this particular yellow mode is obtained from a quarry in a geographical region in or around Lowell, Fla. Another quarry near Crawford, Tex. has products with similar characteristics; e.g., L=+82.9; a=+1.3; b=+7.6. Even with such positive “b” numbers, it is interesting to note that neither of these fillers have a yellow cast to the naked eye. They look “off-white,” e.g., a light gray color.

In other modes, the source-indicative spectral characteristic of the completed glass mat is a generally blue coloration. Differing ones of these generally bluish modes have somewhat different specific spectral characteristics. For instance, in one example such blue mode the specific spectral characteristic of the completed glass mat is characterized substantially by the following coordinates in L*a*b color space: L=+73.15; a=−10.49; and b=−8.75. In another example blue mode, the specific spectral characteristic of the completed glass mat is characterized substantially by the following coordinates in L*a*b color space: L=+67.58; a=−8.48; and b=−7.68. For all blue color modes the spectral characteristic is characterized by the L*a*b color space having the following ranges: +65≦L≦+75; −15≦a≦−4.0; and, −25≦b≦−5.0.

In yet other modes, the source-indicative spectral characteristic of the completed glass mat is a general pink coloration. Differing ones of these generally pinkish modes have somewhat different specific spectral characteristics. For instance, in one example such pink mode the specific spectral characteristic of the completed glass mat is characterized substantially by the following coordinates in L*a*b color space: L=+69.09; a=+12.81; and b=+3.99. In another example pink mode, the specific spectral characteristic of the completed glass mat is characterized substantially by the following coordinates in L*a*b color space: L=+64.44; a=+19.91; and b=+3.41. For all pink color modes the spectral characteristic of the completed glass mat is characterized by the L*a*b color space having the following ranges: +60≦L≦+75; +10≦a≦+20; and, +2.0≦b≦+5.0.

In still further modes, the source-indicative spectral characteristic of the completed glass mat is a generally silver or gray coloration. Differing ones of these generally silver or grayish modes have somewhat different specific spectral characteristics. For instance, in one example such silver mode the specific spectral characteristic of the completed glass mat is characterized substantially by the following coordinates in L*a*b color space: L=+65.63; a=+0.50; and b=+4.10. For all silver color modes the spectral characteristic of the completed glass mat is characterized by the L*a*b color space having the following ranges: +40≦L≦+70; 0≦a≦+1.0; and, +1.0≦b≦+5.0.

The glass mat substrate typically comprises non-woven glass fibers. In some modes, the raw glass mat substrate has a weight which is between about twelve (12) pounds per thousand square feet and about fifty (50) pounds per thousand square feet. In one example, the glass mat substrate before coating weighs about fourteen and a half (14.5) pounds per thousand square feet (a.k.a. “per MSF”).

### BRIEF DESCRIPTION OF THE DRAWINGS

FIG. 1 is a schematic view of representative apparatus utilized in a coating process for a glass mat.

FIG. 2 is a flowchart illustrating basic, non-limiting, representative steps of an example method of making a coated glass mat comprising having a desired coloration.

### DETAILED DESCRIPTION

In the following description, for purposes of explanation and not limitation, specific details are set forth such as particular compositions, techniques, etc. in order to provide a thorough understanding. However, it will be apparent to those skilled in the art that the present invention may be practiced in other embodiments that depart from these specific details. In other instances, detailed descriptions of well known substances and methods are omitted so as not to obscure the description of the present invention with unnecessary detail. It will be further understood that in the ensuing description and claims that the terms “web” and “mat” are employed interchangeably, and in the sense that the mats and webs can be used as “facers”, all three terms may be utilized interchangeably.

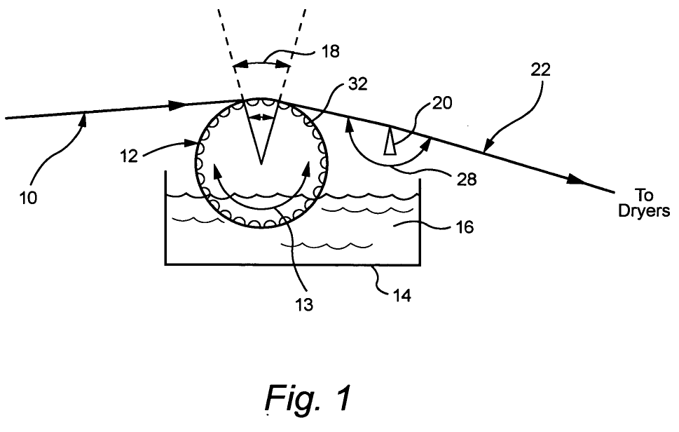

FIG. 1 illustrates representative apparatus for applying a coating mixture to a mat to form a product for use, e.g., as a facer for a plastic foam board, or a gypsum board, or a composite wood particle board, or plywood, or any other type of building construction board. The mat is a substantially porous, predominately non-woven glass mat substrate, and therefore is referenced herein as a “glass mat” or “glass mat substrate”.

As shown in FIG. 1, a raw glass mat 10 (e.g., the “substrate”) enters a coating station at a level lower than a top of an applicator roll 12. The direction of travel of the glass mat 10 is parallel to a “machine direction” (M.D.) of a facer produced by the machine, while a dimension perpendicular to the machine direction and perpendicular to the plane of FIG. 1 is understood to be parallel to a “cross machine direction” (C.M.D.) of a resultant facer similarly oriented. The applicator roll is driven to rotate about its axis (either clockwise or counterclockwise, as depicted by arrow 13). A coating pan 14 is filled with a coating mix 16 up to a level that is sufficient for the applicator roll 12 to pull an adequate amount of coating to the top of the applicator roll 12. The speed of rotation of applicator roll 12 is established to get adequate amounts of coating mix 16 up into the glass mat 10 as the glass mat 10 is conveyed. In its path of conveyance, the glass mat 10 extends around applicator roll 12 in a wrap-arc 18. A scraper blade 20 is placed so that the excess coating scraped off returns into the coating pan 14. After the excess is scraped off, the coated mat proceeds into a dryer section (not shown) where the coated glass mat facer 22 is dried and wrapped into rolls.

The apparatus of FIG. 1 is illustrated as a non-limiting basic example of the type of equipment which can be utilized to coat a glass mat and to achieve the desired spectral characteristics described herein. Other types of coating apparatus can also be utilized to obtain the spectral characteristics, including variations of the apparatus of FIG. 1 such as the prior art embodiments and the inventive embodiments described in U.S. patent application Ser. No. 10/891,485 filed Jul. 15, 2004, entitled “METHOD AND COMPOSITION FOR COATING MAT AND ARTICLES PRODUCED THEREWITH”, which is a continuation-in-part of U.S. patent application Ser. No. 10/324,109 filed Dec. 20, 2002, both of which are incorporated herein by reference.

When using the inventive embodiments of the aforementioned patent applications, the coating of the coated glass mat advantageously achieves a further benefit of penetrating deeply into the thickness of the mat, e.g., from approximately 25% up to 75% of the mat thickness, thereby affording higher tensile strengths. To whatever depth in this range (25% up to 75% of the mat thickness) the coating extends, it does so essentially uniformly. Yet the coated glass mat has about the same coating percentage composition by weight per square unit area as other coated mats. The uncoated thickness (e.g., approximately 25% up to 75% of the thickness) of the glass mat is sufficiently thick for bonding purposes with, e.g., a gypsum slurry or other core materials such as thermoplastic or thermosetting plastics. Typically in such embodiments the raw, uncoated glass mat substrate has a weight which is between about twelve (12) pounds per thousand square feet and about fifty (50) pounds per thousand square feet. In an example embodiment, the uncoated mat weighs about 21.0-lbs per MSF.

The methods described in the aforementioned patent applications and the penetration advantages derived therefrom are not necessary to achieve the spectral characteristics of this invention, but may be employed in conjunction with the coatings described herein for attaining the desired spectral characteristics. In fact, essentially any prior art method of coating a moving web can be utilized with the coatings described herein for attaining the desired spectral characteristics. Some other types of coater examples include, but are not limited to: trailing-blade; air-knife; metering-bar; size-press; gate-roll; kiss-roll, Massey; Bill-blade; slot-die; flexi-blade; twin-blade; and inverted-blade.

As mentioned above, it was discovered that when using a dispersed pigment colorant in a coating mixture, the resultant color of the coated glass mat was not identical, and in fact often dissimilar, to the ostensible color of the dispersed pigment colorant utilized in the coating mixture. Example 1, provided below, illustrates an example of such a situation. In Example 1, an off-white colored limestone obtained from Crab Orchard, Tenn., USA, (designated herein as Crab Orchard 95/200) was utilized. When a dispersed, clean, bright, yellow colorant (Engelhard W-1318) was added to a coating mixture which included the Crab Orchard 95/200 limestone, the resultant coating, rather than being yellow, took on a dusty green color.

### EXAMPLE 1

### An Unacceptable Filler

For Example 1, a batch of coating mixture is made by adding 80.5-grams of water to a mixing beaker having a low speed mixer. This is followed by 1.2-grams of a sodium salt of poly-naphthylmethanesulfonate dispersing agent, such as Galoryl® DT 400 N. Then is added 30.0-grams of a carboxylated SBR latex, such as Styrofan® ND5406, followed by 2.0-grams of Engelhard W-1318 (dispersed yellow colorant) and 388.5-grams of limestone from Crab Orchard, Tenn. USA This produces a 502.2-gram batch of coating mixture having a viscosity of about 300 centipoise (cps) at 250° C.

The coating mixture of Example 1 was applied using the Gardner Knife to a non-woven glass mat: Saint-Gobain's “Vetrotex 2.10 Facer Mat”. Later, Dura-Glass® 7594 made by Johns Manville was utilized. The glass mat weight averaged about 21.0-lbs/MSF (thousand square feet), and had a thickness average of about 0.025-inches. For Examples 1 through 3, the same glass mat was utilized; i.e., the “Vetrotex 2.10 Facer Mat”. The final coated product weight averaged about 93.0-lbs/MSF, indicating that the coating solids added about 72.0-lbs/MSF.

The L*a*b coordinates of the dried sheet of Example 1 were: L=+73.61; a=−4.03; b=+57.38. The −4.03 “a” coordinate is a distinct green. The resultant color of the mat of Example 1 was unacceptable. By way of contrast, the color of a desirable mat (produced with another limestone source) had a L*a*b value of about L=+78.6; a=+1.2; b=+52.2. The “a” of +1.2 for the acceptable color is not red enough to be discernable. The color of the acceptable mat was a clean, bright yellow.

Note that the unacceptable mat of Example 1 with its green color comprised a higher L*a*b yellow value; e.g., “b”=+57.38, as compared to the acceptable mat with only a “b”=+52.2. Nevertheless even with its lower yellow 1o coordinate value, the acceptable mat had superior coloration. The green value of a=−4.03 dominated the visual appearance of the unacceptable mat of Example 1. Further, the lower brightness of the unacceptable mat (L=+73.61) of Example 1 unfavorably compared to the brighter L=+78.6 for the acceptable mat, thereby accounting for the “dusty” or “muted” gray tint of green.

In fact, despite its ostensible “colorless” off-white color, the inventors have not yet been able to use the filler materials from Crab Orchard, Tenn. USA to make an acceptable yellow colored coating, regardless of the combination of dispersed yellow colorants or other pigments. Futile attempts were made to mask the green by adding whiteners such as titanium dioxide dispersed colorant, but nothing worked. Even using a brighter batch of Crab Orchard 95/200 limestone with a more positive red component (L*a*b color space coordinates L=+71.2; a=+1.95; b=+4.32); the resulting dried sheet was still too murky. Although it had no green component, apparently, the strong “black/dark” factor of L=+71.2 causes the yellow to shade toward green. It is widely known that black has a strong blue component. The evidence indicates that it may well be that the filler brightness must be over about +82 in order to make a good yellow coating, regardless of the filler's good “a” and “b” values. Only after discarding the Crab Orchard 95/200 filler was progress made. However, along the way it was discovered that even a small amount of green in the coating presented an unacceptable color, shown in Example 2, where a different filler was used.

### EXAMPLE 2

### Another Unacceptable Filler

The coating batch of Example 2 was made utilizing 89.0-grams water, 1.5-grams Galoryl® DT 400 N, 39.5-grams BASF's Optive-600 latex, 0.8-grams Engelhard W-1241 (dispersed yellow colorant), and 349.5-grams of Global Stone's CISCO 90. It was thought that using this filler with its L=+85.1 brightness (Table 2), a clean yellow could be achieved. The L*a*b of this dried coated glass mat was: L=+76.33; a=−0.26; and b=+47.27. Even with a green content as small as “a=−0.26”, plus a relatively good brightness of +76.33, this color was marginally unacceptable. By doubling the W-1241 to 1.6-grams, the L*a*b results were L=+73.91; b=+1.19; and the a=+63.49, but the visual appearance was still too dark to be acceptable.

### Advancements to Acceptable Filler

Upon realizing that filler choice could be a significant if not insurmountable factor for mat coloration, the inventors concluded that the type and amount of the mineral pigment filler could be judiciously chosen to impart a predetermined spectral characteristic to the coated glass mat upon drying. Examples provided below confirm this conclusion. Moreover, even when the coating mixture may include a separate, optional colorant, the mineral pigment filler is chosen as a primary color determinate for the completed coated glass mat.

The primary determinative influence of the mineral pigment filler on the spectral characteristic of the coated glass mat is evident by the relative amounts of the mineral pigment filler and the colorant. In particular, a maximum ratio of “as received weight” of colorant to “dry weight” of filler is less than about 0.004; in some modes is less than about 0.003 (e.g., about 1-gram per 335-grams); and in some modes the preferred ratio is as low as about 0.001 (e.g., about 0.25-gr/388.5-gr=0.000644). Alternatively, since the pre-dispersed liquid colorants are all roughly 50% dry solids content, the level of colorant used can be stated as the ratio of “dry weight” of colorant to the “dry weight” of filler, in which case the maximum ratio is about half as much, e.g., 0.002, (since, for example, 0.5/335 is 0.0015).

Advantageously, use of the inexpensive mineral pigment filler as the primary color determinate for the completed coated glass mat obviates the need for larger amounts of more expensive colorant, thereby providing economy as well as efficiency in production.

In most cases, the spectral characteristic of the completed coated glass mat is different than a pre-mixture spectral characteristic of the mineral pigment filler, even though the mineral pigment filler so decisively affects the spectral characteristic of the completed coated glass mat.

In some modes, the preferable mineral pigment filler is limestone. The spectral characteristic of the completed glass mat, attained by use of a particularly selected limestone in the coating mixture, can be any source-indicative color, such as yellow, blue, pink, or silver for example.

EXAMPLE 3

### Acceptable Yellow Color

The coating batch of Example 3 was made utilizing 87.4-grams water, 1.7-grams Galoryl® DT 400 N, 53.9-grams Dow's NeoCAR-820 latex, 1.0-grams Engelhard W-1241 (dispersed yellow colorant), and 356.0-grams of Franklin Mineral's Lowell 90/200. The L*a*b coordinates of the dry powdered Lowell, Fla. limestone has a “b” value higher than +7.0, on average. The final L*a*b coordinates of this dried coated glass mat were: L=+83.87; a=+0.44; and b=+53.45. Both the color and the Cobb test results were deemed acceptable. Note that Example 3 comprised an “as-received” colorant-to-filler ratio of 1/356=0.0028; and that the Example 1 ratio was 2/388.5=0.0052. When utilizing a ratio of 0.0052 for the Example 3 formulation using Lowell, Fla. limestone, the yellow color is very intense, having a “+b” number from about +58 to about +60.

### EXAMPLES 4-7

### Acceptable Blue Color

Even though the Crab Orchard, Tenn. limestone has a heavy blue tint, the initial trials of this limestone without significant amounts of other pigments did not provide a desired particular blue color for a coated glass mat. Rather, it was determined that Franklin Industrial Mineral's A 90/200 limestone from Sherwood, Tenn. has the unique properties needed to meet the requested blue color when utilizing the dispersed colorant, Engelhard W-4150, at the example ratio, e.g., 0.000644. Another interesting discovery made is that some fillers were so void of “gray” tinting, that they produced a blue that was deemed “too blue”. This subjective appraisal is often the phrase used when the actual blue is too clean, or void of gray shade tinting power, rather than actually having a negative “b” number that is too large.

Examples 4, 5, and 6 of Table 1 illustrate formulations for obtaining blue coloration, and further show how changing fillers will create substantially different finished product colors even though one colorant dispersion (Engelhard W-4150) is held at a constant level of addition. Example 7 illustrates how an acceptable blue color can be obtained utilizing an alternative method. When more Engelhard W-4150 was added to the Example 4 batch, the color was still not acceptable. But changing to a slightly different dispersed blue colorant, in this case Engelhard W-4123, and adding twice the level; e.g., from 0.25-gr to 0.50-gr per 388.5-gr batch, the blue color became acceptable while using the Crab Orchard, Tenn. 95/200 limestone. The glass mat used for Examples 4 through 10 weighed about 21.0-pounds per MSF (thousand square feet).

TABLE 1

| COATING MIX: | EXAMPLE 4 | EXAMPLE 5 | EXAMPLE 6 | EXAMPLE 7 |
|---|---|---|---|---|
| Water: | 80.5-grams | 80.5-grams | 80.5-grams | 80.5-grams |
| Galoryl DT 400 N: | 1.2-grams | 1.2-grams | 1.2-grams | 1.2-grams |
| BASF Styrofan ND-5406: | 30.0-grams | 30.0-grams | 30.0-grams | 30.0-grams |
| Crab Orchard, TN 95/200: | 388.5-grams | | | 388.5-grams |
| Global Stone GFP 101: | | 388.5-grams | | |
| Sherwood, TN A-90/200: | | | 388.5-grams | |
| Engelhard W-4150 Blue: | 0.25-grams | 0.25-grams | 0.25-grams | |
| Engelhard W-4123 Blue: | | | | 0.50-grams |
| TOTAL BATCH: | 500.45-gr | 500.45-gr | 500.45-gr | 500.70-gr |
| RATIO of the “As-Is” | 0.000644 | 0.000644 | 0.000644 | 0.001287 |
| colorant to the dry Filler | | | | |
| Dried coated mat: L = | +69.24 | +64.98 | +73.15 | +67.58 |
| Dried coated mat: a = | −10.22 | −17.03 | −10.49 | −8.48 |
| Dried coated mat: b = | −6.86 | −28.29 | −8.75 | −7.68 |
| Customer's opinion: | Murky blue | Too blue | Good blue | Okay blue |

The visual appearance of these filler pigments is of no real value in deciding which ones to evaluate. The visual differences are really only seen as degrees of brightness. The so-called “Brightness” is technically the “Whiteness”, as evidenced by higher L numbers.

Table 2 shows the L*a*b coordinates, e.g., three dimensional numbers, for ten (10) fillers in dry, powdered form. Even after measuring these L*a*b values, the numbers only help to a limited extent. While the high yellow content of the Lowell, Fla. USA limestone (b=+8.46) implies that it may be useful in a yellow coating, the major differences noted by most of the L*a*b numbers are the whiteness (L) values. As example, the “a” numbers range only from −0.20 to +1.47, offering little help in choosing a filler for a pink or green shade. Also, the lack of any negative “b” values offers scant help to attain a blue.

Referring to Table 2, the whitenesses of the three Immerys fillers stand out from all others. Only very special coatings can justify the higher cost of these bright fillers. Trying to pick a filler to use in a silver, pink, or blue coating mix by using the L*a*b numbers of Table 2, is no easier than picking one visually.

Surprisingly, the impact of the filler color comes only after it is blended with the other chemicals and is dried after coating on a substrate. It is also surprising that the filler material has at least as much impact on this coated substrate color than does a dispersed colorant made just for color control.

TABLE 2

| Dry Limestone Fillers | L | a | b |
|---|---|---|---|
| Crab Orchard, TN | +69.6 | +1.08 | +3.73 |
| Sherwood, TN | +85.2 | +0.74 | +4.74 |
| Lowell, FL | +90.7 | +0.96 | +8.46 |
| Crawford, TX | +82.9 | +1.29 | +7.60 |
| Global 135 | +90.3 | −0.09 | +2.11 |
| Global GFP 101 | +79.8 | +1.47 | +4.91 |
| Cisco 90 | +85.1 | +1.44 | +4.77 |
| Immerys #10 | +95.7 | −0.20 | +1.76 |
| Immerys Marble Dust | +95.1 | −0.16 | +2.31 |
| Immerys Micro 100 | +95.4 | −0.20 | +1.82 |

### EXAMPLE 8

### Silver Color

For a silver colored coated glass mat of Example 8, the Crab Orchard, Tenn. filler was utilized. The same formulation as Example 4 above was used for Example 8, except 0.25-grams of the Engelhard W-4150 Blue used in Example 4 was replaced with 0.25-grams of Engelhard 7717 Black at the ratio 0.000644. This gray (silver) colored coated glass mat product had L*a*b values of L=+65.63; a=+0.50; b=+4.10.

### EXAMPLES 9-10

### Pink Color

When the Crab Orchard filler is utilized in a coating mix without a colorant, it dries to a beige color. Therefore, as Example 9 a reasonable pink color is easily created using the basic formulation of Example 4, except with Engelhard W-3170 Red substituted as the dispersed colorant. Using the ratio 0.000644 of W-3170, the pink colored coated glass mat product has L*a*b values of L=+69.09; a=+12.81; b=+3.99. As Example 10, doubling the ratio to 0.0013 of W-3170, the values are L=+64.44; a=+19.91; b=+3.41. Of these two pink colors, the second set of values (Example 10) are closer to the most popular pink color used in building products.

Thus, as exemplified above particularly with reference to Example 3, in some modes the source-indicative spectral characteristic of the completed glass mat is a general yellow coloration. Differing ones of these generally yellowish modes have somewhat different specific spectral characteristics. For instance, in one example such yellow mode the specific spectral characteristic is characterized substantially by the following coordinates in L*a*b color space: L=+78.6; a=+1.2; and b=+52.2. In another example yellow mode, the specific spectral characteristic is characterized substantially by the following coordinates in L*a*b color space: L=+83.87; a=+0.44; and b=+53.45. In all such yellow modes, the limestone is characterized by coordinates in L*a*b color space wherein color space coordinate b is greater than or equal to +7.0, on average. In fact, for all yellow color modes the spectral characteristic of the filler is characterized by the L*a*b color coordinate ranges: +82≦L≦+92; 0≦a≦+1.5; and, +2.0≦b≦+8.5. Likewise, the finished yellow product is characterized by coordinates in L*a*b color space having the following ranges: +75≦L≦+85; −1.0≦a≦+1.5; and, +50≦b≦+58.

In one such yellow mode, a pre-mixture spectral characteristic of the mineral pigment filler is characterized substantially by the following coordinates in L*a*b color space: L=+90.7; a=+0.96; and b=+8.46. A mineral pigment filler for this particular yellow mode is obtained from a quarry in a geographical region in or around Lowell, Fla., USA.

In another such yellow mode, the mineral pigment filler is obtained from a quarry in a geographical region in or around Crawford, Tex., and has the following approximate coordinates in L*a*b color space: L=+82.9; a=+1.29; and b=+7.60.

In other modes, typified by Examples 4-7, the source-indicative spectral characteristic of the completed glass mat is a generally blue coloration. Differing ones of these generally bluish modes have somewhat different specific spectral characteristics. For instance, in one example such blue mode the specific spectral characteristic is characterized substantially by the following coordinates in L*a*b color space: L=+73.15; a=−10.49; and b=−8.75. In another example blue mode, the specific spectral characteristic is characterized substantially by the following coordinates in L*a*b color space: L=+67.58; a=−8.48; and b=−7.68. For all blue color modes the spectral characteristic is characterized by the L*a*b color space having the following ranges: +65≦L≦+75; −15≦a≦−4.0; and, −25≦b≦−5.0.

In yet other modes such as that illustrated by Example 8, the source-indicative spectral characteristic of the completed glass mat is a generally silver or gray coloration. Differing ones of these generally silver or grayish modes have somewhat different specific spectral characteristics. For instance, in one example such silver mode the specific spectral characteristic of the finished glass mat is characterized substantially by the following coordinates in L*a*b color space: L=+65.63; a=+0.50; and b=+4.10. For all silver color modes the spectral characteristic of the finished glass mat is characterized by the L*a*b color space having the following ranges: +40≦L≦+70; 0≦a≦−+1.0; and, +1.0≦b≦+5.0.

In still further modes represented by Examples 9 and 10, the source-indicative spectral characteristic of the completed glass mat is a general pink coloration. Differing ones of these generally pinkish modes have somewhat different specific spectral characteristics for the finished glass mat. For instance, in one example such pink mode the specific spectral characteristic of the finished glass mat is characterized substantially by the following coordinates in L*a*b color space: L=+69.09; a=+12.81; and b=+3.99. In another example pink mode, the specific spectral characteristic of the finished glass mat is characterized substantially by the following coordinates in L*a*b color space: L=+64.44; a=+19.91; and b=+3.41. For all pink color modes the spectral characteristic of the finished glass mat is characterized by the L*a*b color space having the following ranges: +60≦L≦+75; +10≦a≦+20; and, +2.0≦b≦+5.0.

The glass mat substrate which is coated by the coating formulations described herein typically comprises non-woven glass fibers. In some modes, the raw glass mat substrate has a weight which is between about twelve (12) pounds per thousand square feet and about fifty (50) pounds per thousand square feet. In Examples 4 through 10, the glass mat substrate before coating weighs about fourteen and a half (14.5) pounds per thousand square feet.

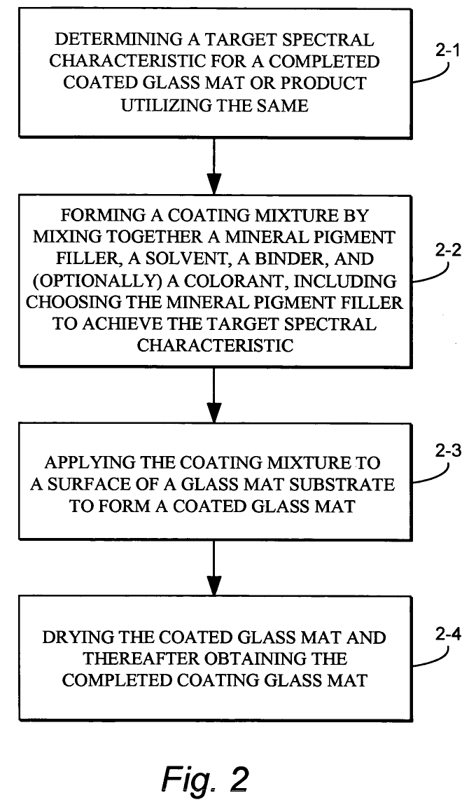

FIG. 2 is a flowchart illustrating basic, non-limiting, representative steps of an example method of making a coated glass mat comprising having a desired coloration. Step 2-1 involves determining a target spectral characteristic for a completed coated glass mat or product utilizing the same. The target spectral characteristic may be mandated by customer or manufacturer requirement/specification for marketing or other consumer recognition purposes, for example. Step 2-2 involves forming a coating mixture by mixing together a mineral pigment filler, a solvent, a binder, and (optionally) a colorant. As part of step 2-2, the mineral pigment filler is chosen to achieve the target spectral characteristic. Non-limiting examples of coating mixtures and choice of mineral pigment filler are illustrated by Examples 3-10 described herein. Step 2-3 involves applying the coating mixture to a surface of a glass mat substrate to form a coated glass mat. Thereafter, step 2-4 involves drying the coated glass mat and thereafter obtaining the completed coated glass mat.

The coated glass mat is advantageously employed in a laminate product. Many companies use color to identify their laminated products. Thus the ability to match color requests at the lowest cost possible is important.

By utilizing various fillers from different quarries to get good color matching, the cost of dispersed colorant is minimized. Advantageously, the methods described herein create desired colors by utilizing low-cost filler materials instead of using high levels of factory-prepared dispersed colorants made just for color control. While providing the above mentioned desirable properties, the coated glass mat/facer remains a low-cost product due, e.g., to its using economy grade limestone in rich abundance and very little of the high-cost polymer latexes.

While the L*a*b coordinates are utilized herein to describe color phenomena, it will be appreciated that other color descriptive systems can also be utilized for expressing the spectral characteristics achieved by, e.g., judicious choice of mineral pigment filler.

Likewise, the dispersed colorants optionally utilized in some of the foregoing mixture formulations can be obtained from comparable products to the Engelhard products described herein, including products from other vendors. Also it must be appreciated that many forms of colorants can be employed, such as the dry powder form of the pre-dispersed liquid material generally preferred, and shown exclusively herein.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of making a coated glass mat comprising:
forming a coating mixture by mixing together a mineral pigment filler, a solvent, and a binder;
applying the coating mixture to a surface of a glass mat substrate to form a coated glass mat;
drying the coated glass mat;
the mineral pigment filler having been chosen to impart a predetermined spectral characteristic to the coated glass mat upon drying.

2. A method of making a coated glass mat comprising:
forming a coating mixture by mixing together a mineral pigment filler, a solvent, and a binder;
applying the coating mixture to a surface of a glass mat substrate to form a coated glass mat;
drying the coated glass mat;
the mineral pigment filler having been chosen as a primary color determinate for the coated glass mat.

3. The method of claim 2, wherein the mineral pigment filler is chosen as the primary color determinate for imparting a predetermined spectral characteristic to the coated glass mat.

4. A method of making a coated glass mat comprising:
determining a target spectral characteristic for a completed coated glass mat;
forming a coating mixture by mixing together a mineral pigment filler, a solvent, and a binder;
applying the coating mixture to a surface of a glass mat substrate to form a coated glass mat;
drying the coated glass mat and thereafter obtaining the completed coating glass mat;
the mineral pigment filler having been chosen to achieve the target spectral characteristic.

5. A method of making a coated glass mat comprising:
forming a coating mixture by mixing together a mineral pigment filler, a solvent, a binder, and a colorant;
applying the coating mixture to a surface of a glass mat substrate to form a coated glass mat;
drying the coated glass mat;
a type of the mineral pigment filler, an amount of the mineral pigment filler, and an amount of the colorant being chosen to impart a predetermined spectral characteristic to the coated glass mat upon drying; and
wherein a ratio of a dry weight amount of the colorant to a dry weight amount of the mineral pigment filler included in the coating mixture is less than 0.002.

6. The method of claim 5, wherein the colorant is a pre-dispersed liquid colorant, and wherein the ratio of an as-received weight amount of the pre-dispersed liquid colorant to the dry weight amount of the mineral pigment filler included in the coating mixture is less than about 0.004.

7. The method of claim 1, claim 3, claim 4, or claim 5, wherein the target or predetermined spectral characteristic is different than a pre-mixture spectral characteristic of the mineral pigment filler.

8. The method of claim 1, claim 3, claim 4, or claim 5, wherein the spectral characteristic of the coated glass mat upon drying is a source-indicative spectral characteristic.

9. The method of claim 7, wherein the pre-mixture spectral characteristic of the mineral pigment filler is characterized by coordinates in L*a*b color space wherein color space coordinate b is greater than or equal to +7.0, on average.

10. The method of claim 1, 2, or claim 4, wherein the coating mixture further comprises a colorant, and wherein a ratio of a dry weight amount of any colorant to a dry weight amount of the mineral pigment filler included in the coating mixture is less than about 0.002 and preferably less than about 0.001.

11. The method of claim 1, 2, claim 4, or claim 5, wherein the coating mixture further comprises a colorant, and wherein a dry weight amount of any colorant does not exceed 0.4% of total dry weight of the coating mixture.

12. The method of claim 1, 2, claim 4, or claim 5, wherein the mineral pigment filler is limestone.

13. The method of claim 12, wherein the limestone is characterized by coordinates in L*a*b color space wherein color space coordinate b is greater than or equal to +7.0, on average.

14. The method of claim 1, 2, or 4, wherein the binder is an organic latex.

15. The method of claim 1, claim 3, claim 4, or claim 5, wherein the spectral characteristic of the mineral pigment filler is a yellow color characterized by coordinates in L*a*b color space wherein color space coordinate b is greater than or equal to +7.0, on average.

16. The method of claim 1, claim 3, claim 4, or claim 5, wherein the spectral characteristic of the coated glass mat product is a yellow color characterized by coordinates in L*a*b color space having the following ranges: L=+75≦L≦+85; −1.0≦a≦+1.5; and, +50≦b≦+58.

17. The method of claim 16, wherein a pre-mixture spectral characteristic of the mineral pigment filler is characterized substantially by coordinates in L*a*b color space having the following ranges: +82≦L≦+92; 0≦a≦+1.5; and, +2.0≦b≦+8.5.

18. The method of claim 16, wherein the mineral pigment filler is obtained from a geographical region in or around Lowell, Fla.

19. The method of claim 16, wherein the mineral pigment filler is obtained from a geographical region in or around and Crawford, Tex.

20. The method of claim 16, wherein the spectral characteristic of the coated glass mat product is characterized substantially by the following coordinates in L*a*b color space: L=+78.6; a=+1.2; and b=+52.2.

21. The method of claim 16, wherein the spectral characteristic of the coated glass mat product is characterized substantially by the following coordinates in L*a*b color space: L=+83.87; a=+0.44; and b=+53.45.

22. The method of claim 1, claim 3, claim 4, or claim 5, wherein the spectral characteristic of the coated glass mat product is a blue color characterized substantially by coordinates in L*a*b color space having the following ranges: +65≦L≦+75; −15≦a≦−4.0; and, −25≦b −5.0.

23. The method of claim 22, wherein the spectral characteristic of the coated glass mat product is characterized substantially by the following coordinates in L*a*b color space: L=+73.15; a=−10.49; and b=−8.75.

24. The method of claim 22, wherein the spectral characteristic of the coated glass mat product is characterized substantially by the following coordinates in L*a*b color space: L=+67.58; a=−8.48; and b=−7.68.

25. The method of claim 1, claim 3, claim 4, or claim 5, wherein the spectral characteristic of the coated glass mat product is a silver color characterized substantially by coordinates in L*a*b color space having the following ranges: +40≦L≦+70; 0≦a≦+1.0; and, +1.0≦b≦+5.0.

26. The method of claim 25, wherein the spectral characteristic of the mineral pigment filler is characterized substantially by the following coordinates in L*a*b color space: L=+65.63; a=+0.50; and b=+4.10.

27. The method of claim 1, claim 3, claim 4, or claim 5, wherein the spectral characteristic of the coated glass mat product is a pink color characterized by coordinates in L*a*b color space having the following ranges: +60≦L≦+75; +10≦a≦+20; and, +2.0≦b≦+5.0.

28. The method of claim 26, wherein the spectral characteristic of the coated glass mat product is characterized substantially by the following coordinates in L*a*b color space: L=+69.09; a=+12.81; and b=+3.99.

29. The method of claim 26, wherein the spectral characteristic of the coated glass mat product characterized substantially by the following coordinates in L*a*b color space: L=+64.44; a=+19.91; and b=+3.41.
